(19) United States
(12) Patent Application Publication
(10) Pub. No.: US 2008/0236854 A1
(43) Pub. Date: Oct. 2, 2008

(54) Auxiliary twisting adjusting device of a dynamic machine

(76) Inventor: Chih-Ching Hsieh, Taichung Hsien (TW)

Correspondence Address: Chih Ching Hsieh, 235 Chung-Ho, Box 8-24, Taipei, TW

(21) Appl. No.: 11/731,863

(22) Filed: Apr. 2, 2007

(51) Int. Cl. B23Q 5/00

(52) U.S. Cl. 173/182

(57) ABSTRACT

An auxiliary twisting adjusting device of a dynamic machine comprises a receiving device having a head and a body portion; the head having a hollow embedding groove; the body portion is a long bar; the strain gauge having a hollow bar and an adjustable portion; one end of the bar serving to combine with the body portion of the receiving device; another end of the bar being connected to the adjustable portion; wherein a pneumatic device can be received in the embedding groove of the receiving device; and the adjustable portion can adjust a setting value of the twisting force; when the applied twisting force from the pneumatic device to a driving object is greater than the setting value, the pneumatic device will stop its operation.

### FIELD OF THE INVENTION

The present invention relates to pneumatic devices, and particularly to an auxiliary twisting adjusting device of a dynamic machine, wherein a strain gauge is used to assist the operation of a pneumatic device so as to precisely control the operation of the pneumatic device.

### BACKGROUND OF THE INVENTION

Pneumatic devices are currently used in screwing or releasing screws or studs in mechanic works. High compressing air is used to increase the twisting force for driving the pneumatic device. However, the prior art pneumatic device has no strain gauge. Thus, in locking the devices, such as engine casing, cylinder, clutch, etc., manual twisting spanners are used to perform precise operation. However, time, labor and cost are wasted. Thereby there is an eager demand for a novel design which can improve above mentioned defects.

### SUMMARY OF THE INVENTION

Accordingly, the primary object of the present invention is to provide an auxiliary twisting adjusting device of a dynamic machine, wherein a strain gauge is used to assist the operation of a pneumatic device so as to precisely control the operation of the pneumatic device.

To achieve above objects, the present invention provides an auxiliary twisting adjusting device of a dynamic machine which comprises a receiving device having a head and a body portion; the head having a hollow embedding groove; the body portion is a long bar; the strain gauge having a hollow bar and an adjustable portion; one end of the bar serving to combine with the body portion of the receiving device; another end of the bar being connected to the adjustable portion; wherein a pneumatic device can be received in the embedding groove of the receiving device; and the adjustable portion can adjust a setting value of the twisting force; when the applied twisting force from the pneumatic device to a driving object is greater than the setting value, the pneumatic device will stop its operation.

An interior of the bar is installed with a supporting portion. The supporting portion includes a top portion, an elastic unit, and a retaining seat. An upper end of the top portion resists against a lower end of the body portion. A lower end of the top portion is connected to one end of the elastic unit; and another end of the elastic unit is connected to the retaining seat; and the retaining seat is connected to the adjustable portion.

The adjustable portion serves to adjust the setting value of the twisting force of the strain gauge, the elastic unit of the supporting portion will compress or extend according to the setting value of the twisting force.

The various objects and advantages of the present invention will be more readily understood from the following detailed description when read in conjunction with the appended drawing.

### BRIEF DESCRIPTION OF THE DRAWINGS

FIGS. 1 and 2 are schematic perspective views about the auxiliary twisting adjusting device of a dynamic machine of the present invention.

FIG. 3 is a lateral cross sectional view about the auxiliary twisting adjusting device of a dynamic machine of the present invention.

FIG. 4 is a schematic perspective view showing the operation of the auxiliary twisting adjusting device of a dynamic machine of the present invention.

FIG. 5 is a schematic perspective view about another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

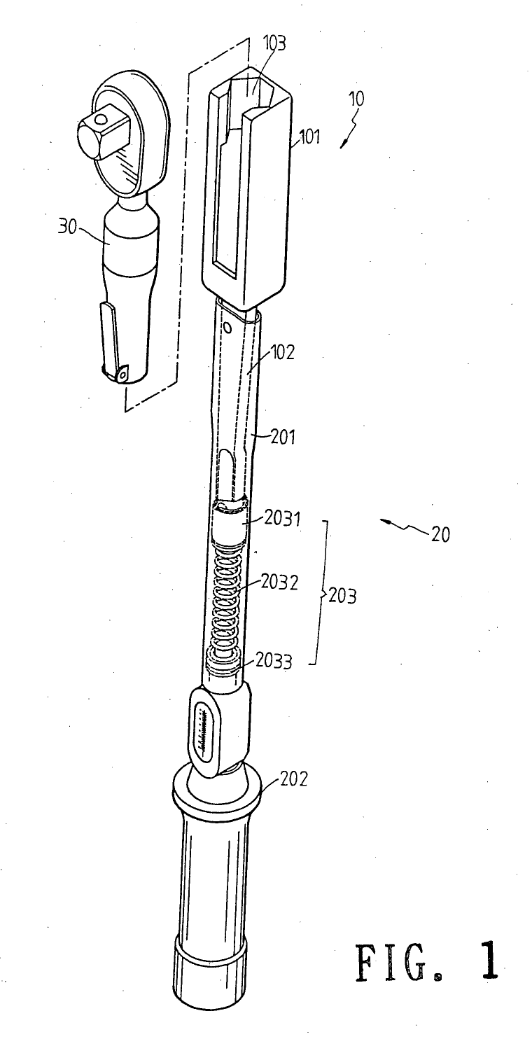

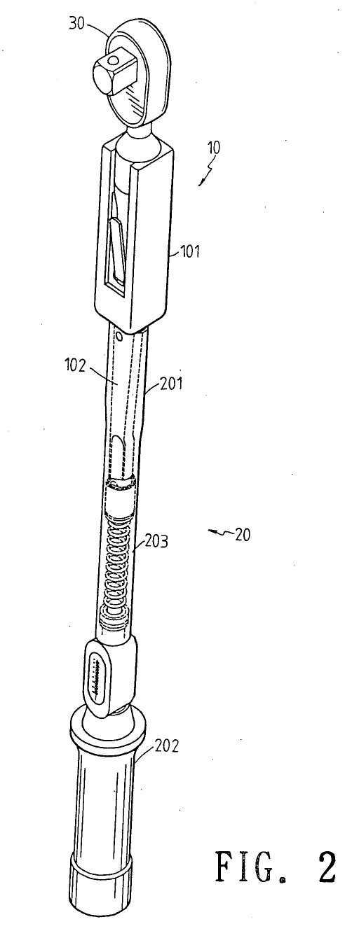

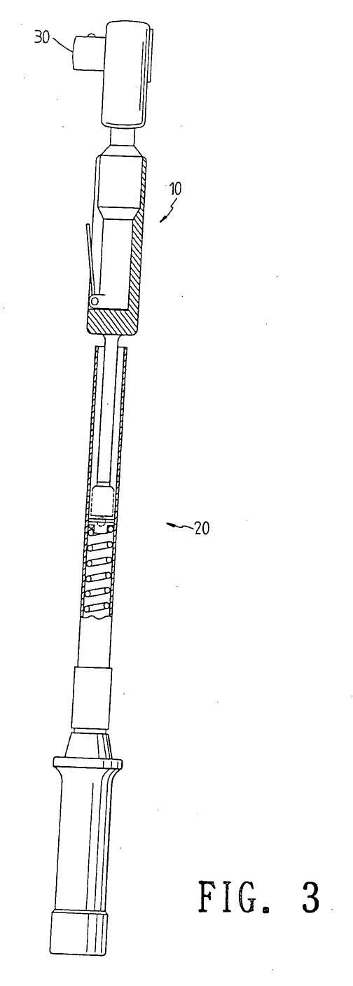

With reference to FIGS. 1 to 3, the auxiliary twisting adjusting device of a dynamic machine has the following elements.

A receiving device 10 has a head 101 and a body portion 102. The head 101 has a hollow embedding groove 103. The body portion 102 is a long bar. The strain gauge 20 has a hollow bar 201 and an adjustable portion 202. One end of the bar 201 serves to combine with the body portion 102 of the receiving device 10. Another end of the bar 201 is connected to the adjustable portion 202.

An interior of the bar 201 is installed with a supporting portion 203. The supporting portion 203 includes a top portion 2031, an elastic unit 2032, and a retaining seat 2033. An upper end of the top portion 2031 resists against a lower end of the body portion 102. A lower end of the top portion 2031 is connected to one end of the elastic unit 2032. Another end of the elastic unit 2032 is connected to the retaining seat 2033. The retaining seat 2033 is connected to the adjustable portion 202.

The function of the adjustable portion 202 is to adjust the set value of the twisting force of the strain gauge 20. A bottom of the adjustable portion 202 is screwable so that the elastic unit 2032 can be tightened or released. By controlling the tightness of the elastic unit, the elastic force is changed. As a result, the elastic unit 2032 of the supporting portion 203 will compress or extend according to the setting value of the twisting force.

The embedding groove 103 of the receiving device 10 can be placed with a pneumatic device 30 for screwing or releasing a nut or a screw. When the applied twisting force has achieved the set value, the body portion 102 of the receiving device 10 will release from the top portion 2031 of the supporting portion 203 so that the pneumatic device 30 can not operate.

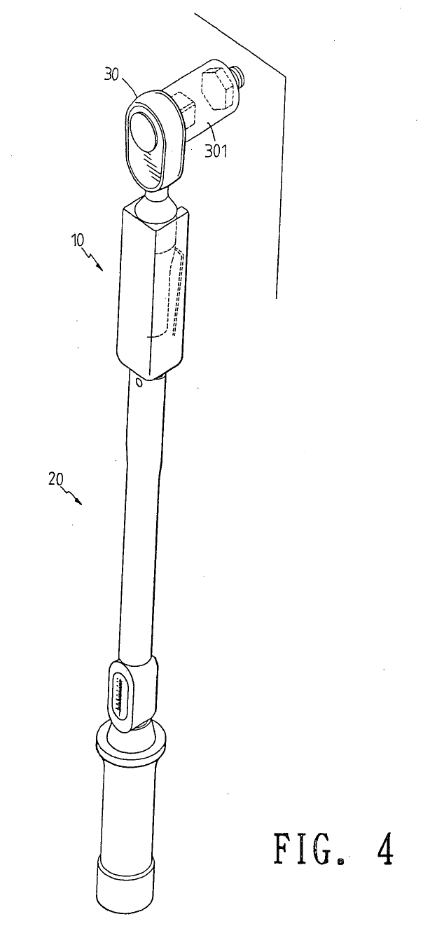

Referring to FIG. 4, the use of the present invention is illustrated. When the pneumatic device 30 is placed into the embedding groove 103 of the receiving device 10, a socket 301 is added to the pneumatic device 30. When the set value of the twisting force is set by the operator, the pneumatic device 30 can be operated for screwing or releasing a screw object.

In the present invention, the head 101 is secured through a pivotal shaft. An end face of the body portion 102 is connected to a cambered surface at a top portion 2031. When the twisting force from the pneumatic device 30 and the embedding groove 103 applied to the body portion 102 is lower than a predetermined value, the elastic force from the elastic unit 2032 will tighten the body portion 102 through the top portion 2031 without separation. When the twisting force from the body portion 102 is over than the predetermined value, the top portion 102 will slide with respect to the top portion 2031.

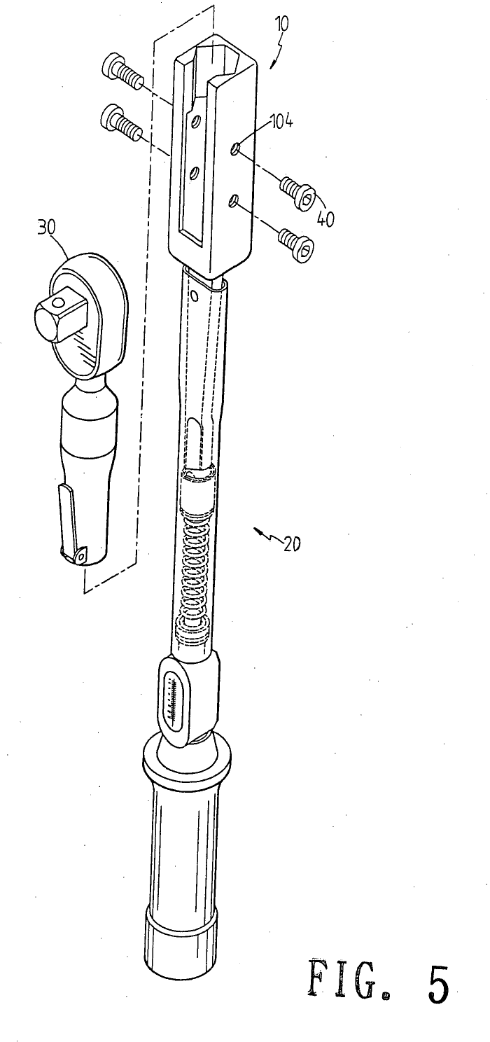

Referring to FIG. 5, another embodiment of the present invention is illustrated. In this embodiment, two sides of the receiving device 10 have formed with a plurality of screw holes 104. Then a plurality of screws 40 passes through the screw holes to lock the pneumatic device 30 in the embedding groove 103 of the receiving device 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An auxiliary twisting adjusting device of a dynamic machine comprising:
a receiving device having a head and a body portion; the head having a hollow embedding groove; the body portion being a long bar; the strain gauge having a hollow bar and an adjustable portion; one end of the bar serving to combine with the body portion of the receiving device; another end of the bar being connected to the adjustable portion;
wherein a pneumatic device can be received in the embedding groove of the receiving device; and the adjustable portion serves to adjust a setting value of the twisting force; when the applied twisting force from the pneumatic device to a driving object is greater than the setting value, the pneumatic device will stop its operation.

2. The auxiliary twisting adjusting device of a dynamic machine as claimed in claim 1, wherein an interior of the bar is installed with a supporting portion; the supporting portion includes a top portion, an elastic unit, and a retaining seat; an upper end of the top portion resists against a lower end of the body portion; a lower end of the top portion is connected to one end of the elastic unit; and another end of the elastic unit is connected to the retaining seat; and the retaining seat is connected to the adjustable portion.

3. The auxiliary twisting adjusting device of a dynamic machine as claimed in claim 1, wherein the adjustable portion serves to adjust the setting value of the twisting force of the strain gauge, the elastic unit of the supporting portion will compress or extend according to the setting value of the twisting force.

4. The auxiliary twisting adjusting device of a dynamic machine as claimed in claim 1, wherein the embedding groove of the receiving device receives a pneumatic device for screwing or releasing a nut or a screw.
